(19) United States
(12) Patent Application Publication
(10) Pub. No.: US 2024/0405224 A1
(43) Pub. Date: Dec. 5, 2024

(54) COATING SOLUTION

(71) Applicant: TOYOTA JIDOSHA KABUSHIKI KAISHA, Toyota-shi (JP)

(72) Inventor: Masaru KUBOTA, Okazaki-shi (JP)

(73) Assignee: TOYOTA JIDOSHA KABUSHIKI KAISHA, Toyota-shi (JP)

(21) Appl. No.: 18/624,436

(22) Filed: Apr. 2, 2024

(30) Foreign Application Priority Data
Jun. 2, 2023 (JP) 2023-091516

(51) Int. Cl. H01M 4/62; H01M 4/02; H01M 4/505; H01M 4/525

(52) U.S. Cl. CPC H01M 4/62; H01M 2004/028; H01M 4/505; H01M 4/525

(57) ABSTRACT

A coating solution used for forming a coating film on a surface of a positive electrode active material, wherein the coating solution includes a solvent and a solute, the solvent includes water, the solute includes M element, the M element includes at least one selected from the group consisting of phosphorus and boron, a content of the M element in the coating solution is 0.05% by mass or more and 3.0% by mass or less, a content of lithium in the coating solution is less than 0.1% by mass, an absorbance in a wavelength 660 nm of the coating solution is 0.1 or less, and a surface energy of the coating solution is 50 mN/m or less.

### CROSS-REFERENCE TO RELATED APPLICATION

This application claims priority to Japanese Patent Application No. 2023-091516 filed on Jun. 2, 2023 incorporated herein by reference in its entirety.

### BACKGROUND

### 1. Technical Field

The present disclosure relates to a coating solution.

### 2. Description of Related Art

Japanese Unexamined Patent Application Publication No. 2022-47501 (JP 2022-47501 A) discloses that slurry containing a positive electrode active material and a coating solution is dropletized and such slurry droplets are flash-dried, in order to uniformly form a coating layer on the surface of the positive electrode active material.

### SUMMARY

The method disclosed in JP 2022-47501 A has advantages such as improving the processing speed as compared with a conventional rolling flow method. In the method disclosed in JP 2022-47501 A, however, the wettability between the positive electrode active material and the coating solution is poor, and therefore it tends to be difficult to increase the coverage of the coating film.

An object of the present disclosure is to provide a coating solution that can have a high coating ability.

(1) A coating solution to be used to form a coating film on a surface of a positive electrode active material, in which:
the coating solution includes a solvent and a solute;
the solvent contains water;
the solute contains an M element;
the M element contains at least one kind selected from the group consisting of phosphorus and boron;
a content of the M element in the coating solution is 0.05% by mass or more and 3.0% by mass or less;
a content of lithium in the coating solution is less than 0.1% by mass;
absorbance of the coating solution at a wavelength of 660 nm is 0.1 or less; and
surface energy of the coating solution is 50 mN/m or less.

The coating ability of the coating solution can be evaluated according to the surface energy. A high coating ability indicates that the coverage tends to increase. When the surface energy of the coating solution is low, it is meant that the wettability between the coating solution and the positive electrode active material is good. When the wettability between the coating solution and the positive electrode active material is good, it is considered that the coating solution is uniformly spread when the coating solution is applied to the surface of the positive electrode active material, and therefore a uniform coating film is formed, improving the coverage.

The coating ability of the coating solution can also be evaluated according to the absorbance. When the absorbance of the coating solution is low, it is meant that the concentration of fine particles contained in the coating solution is low, that is, a significant amount of the solute does not remain undissolved or few insoluble components remain. When the concentration of fine particles contained in the coating solution is low, it is considered that a coating film with less unevenness is formed when the coating solution is applied to the surface of the positive electrode active material, and the non-uniformity of the thickness is also suppressed, improving the coverage.

Further, the content of lithium in the coating solution according to the present disclosure is less than 0.1% by mass. When the content of lithium in the coating solution is less than 0.1% by mass, it is considered that an increase in pH of the solution is suppressed, and the dissolution of the M element in the coating solution is promoted, reducing the surface energy.

The coating solution according to the present disclosure has a surface energy of 50 mN/m or less, an absorbance of 0.1 or less at a wavelength of 660 nm, and a content of lithium of less than 0.1% by mass. In this case, the coating solution may have an excellent coating ability.

(2) In the coating solution according to (1), the coating solution may further contain a surfactant; and a content of the surfactant in the coating solution may be 0.01% by mass or more and 1.5% by mass or less.

(3) In the coating solution according to (1) or (2), the surface energy of the coating solution may be 15 mN/m or more and 30 mN/m or less.

(4) A coating solution to be used to form a coating film on a surface of a positive electrode active material, in which:
the coating solution includes a solvent, a solute, and a surfactant;
the solvent contains water;
the solute contains an M element;
the M element contains at least one kind selected from the group consisting of phosphorus and boron;
a content of the M element in the coating solution is 1.5% by mass or more and 2.6% by mass or less;
a content of lithium in the coating solution is less than 0.1% by mass;
absorbance of the coating solution at a wavelength of 660 nm is 0.1 or less;
surface energy of the coating solution is 15 mN/m or more and 30 mN/m or less; and
a content of the surfactant in the coating solution is 0.1% by mass or more and 1.0% by mass or less.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graphical representation of the surface-energy profile from No. 1 to 3 relative to coverage;

FIG. 2 is a graphical representation of surface-energy versus coverage from No. 4 to 10; and

FIG. 3 is a graphical representation of surface-energy versus coverage for No. 11 and 12.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### Coating Solution

The coating solution includes a solvent and a solute. The solvent comprises water. The solute includes an M element. The M element includes at least one selected from the group consisting of phosphorus (P) and boron (B). The coating solution may further include, for example, a suspended solid (insoluble component), a precipitate, and the like. Note that the “solute” in the present disclosure does not include a surfactant described later.

### Solvent

The solvent comprises water. The solvent preferably contains water as a main component. The solvent may consist of moisture. The solvent may comprise, for example, ion-exchanged water. The solvent preferably contains, for example, ion-exchanged water as a main component. The solvent may comprise, for example, ion-exchanged water. The solvent may comprise any component so long as the solute dissolves. The solvent may include, for example, an alcohol. The solvent may include, for example, ethanol. The term “containing water as a main component” means that the content of water in the solvent exceeds 50% by mass.

The content of water in the coating solution is preferably 90% by mass or more and 97% by mass or less. When the moisture content in the coating solution is less than 90% by mass, the coating operation on the positive electrode active material particles using the coating solution may be difficult. When the content of water in the coating solution is more than 97% by mass, the concentration of the solute in the coating solution is low, and there is a possibility that the coverage of the coating film is not improved. The content of water in the coating solution may be, for example, 91% by mass or more, or 93% by mass or more. The content of the solvent in the coating solution may be, for example, 96% by mass or less, or 95% by mass or less.

The water content in the coating solution is measured by volumetric titration using a Karl Fischer moisture meter. For example, a Karl Fischer moisture meter “MKA-610” manufactured by Kyoto Electronics Industry Co., Ltd. is prepared. For the determination of the water content, a titrant and a solvent are prepared. As the titrant, for example, “product name: manufactured by Composite 5K (Honeywell)”, and as the solvents, “product name: medium K (manufactured by Honeywell) and the like are conceivable. The water content is measured by dehydrating the solvent in the titration flask with the titration solution and charging the coating solution.

### Solute

P is included as a phosphorus compound. Examples of the phosphorus compound include a phosphoric acid compound. The phosphoric acid compound may include, for example, at least one selected from the group consisting of phosphoric anhydride (P₂O₅), orthophosphoric acid, pyrophosphoric acid, metaphosphoric acid, polyphosphoric acid, and sodium, lithium, and potassium salts thereof. The phosphoric acid compounds are preferably metaphosphoric acid, polyphosphoric acid and their sodium, lithium and potassium salts. The metaphosphoric acid and the polyphosphoric acid can have a longer molecular chain than other phosphate compounds. When the solute contains at least one of metaphosphoric acid and polyphosphoric acid, for example, it is expected that a coating film having continuity is easily formed. As a result, for example, an improvement in the coverage rate is expected.

B is included as a boron compound. Examples of the boron compound include a boric acid compound. The boric acid compound may include, for example, at least one selected from the group consisting of orthoboric acid, metaboric acid, and tetraboric acid.

Preferably, the solute comprises P and B. The inclusion of P and B in the solute is expected to further reduce the surface energy.

The content of the M element in the coating solution is 0.05% by mass or more and 3.0% by mass or less. When the content of the M element in the coating solution is less than 0.05% by mass, the concentration of the M element in the coating solution is low, and there is a possibility that the coverage of the coating film is not improved. When the content of the M element in the coating solution exceeds 3.0 wt %, there is a possibility that the M element is not completely dissolved in the coating solution. The content of the element M in the coating solution, for example, may be at least 0.2 mass %, may be at least 0.5 mass %, may be at least 1.0 mass %, or more than 1.5 mass %. The content of the M element in the coating solution may be 2.9 mass % or less, may be 2.8 mass % or less, may be 2.7 mass % or less, and may be 2.6 mass % or less.

The content of Li in the coating solution is less than 0.1% by weight. When the content of Li is 0.1 wt % or more, pH of the solution is increased, there is a possibility that M element is not completely dissolved in the coating solution. The solute may contain a lithium compound as long as the content of lithium (Li) in the coating solution can be less than 0.1 mass %. The lithium compound may include, for example, lithium hydroxide, lithium nitrate, lithium carbonate, and the like.

The concentration of the solute in the coating solution is measured by the following procedure. 0.1 g coating solution is mixed with pure water and hydrochloric acid and heated. After allowing to cool, hydrogen peroxide is further added and heated. After cooling, the sample solution is prepared according to 100 mL. Inductively Coupled Plasma Atomic Emission Spectroscopy (ICP-AES) device is prepared. For example, the concentration of the solute in the coating solution is measured using an ICP-AES device “CP-720” manufactured by Agilent Technologies Co., Ltd.

### Surfactant

The coating solution may further comprise a surfactant. When the coating solution contains a surfactant, the coating ratio is expected to be improved. The surfactant may be an insoluble component. The surfactant may be a dissolved component (solute). The surfactant may have, for example, water solubility. The solubility of the surfactant may improve the coverage. The surfactant may be cationic, anionic, amphoteric, or nonionic. The nonionic nature of the surfactant may improve the coverage. The surfactant may include, for example, at least one selected from the group consisting of a polyether-modified silicone and a polyethylene glycol alkyl ether. Examples of the polyether-modified silicone include “product name: manufactured by SilsurfC208 (SILTECH Co., Ltd.)” and “product name: KF-945 (manufactured by Shin-Etsu Chemical Co., Ltd.)”. Examples of the polyethylene glycol alkyl ether include polyethylene glycol monolauryl ether (manufactured by Tokyo Chemical Industry Co., Ltd.).

The content of the surfactant in the coating solution is preferably 0.01% by mass or more and 1.5% by mass or less. When the content of the surfactant in the coating solution is less than 0.01% by mass, the effect of improving the coverage by including the surfactant may not be obtained. When the content of the surfactant in the coating solution is more than 1.5% by mass, there is a possibility that precipitation occurs or the insoluble component increases. The content of the surfactant in the coating solution may be, for example, 0.1 mass % or more, 0.2 mass % or more, or 0.5 mass % or more. The content of the surfactant in the coating solution may be, for example, 1.4 mass % or less, 1.2 mass % or less, or 1.0 mass % or less.

### Absorbance

The absorbance of the coating solution in the wavelength 660 nm is not more than 0.1. Here, the absorbance in the wavelength 660 nm indicates the intensity of the scattered light by the fine particles present in the coating solution, and the higher the absorbance value, the higher the concentration of the fine particles present in the coating solution, that is, there is a solute residue of the solute, indicating that there are many insoluble components (for example, see JIS-K0101). Then, when a coating solution having a high concentration of fine particles is applied onto the positive electrode active material, the fine particles adhere to the surface of the positive electrode active material, and the coating film becomes uneven, and the thickness of the coating film becomes uneven. When the thickness of the coating film becomes uneven, a portion where the thickness of the coating film is insufficient or a portion where the coating film is not covered is generated, which leads to a decrease in the coverage ratio.

When the absorbance in the wavelength 660 nm of the coating solution is 0.1 or less, the concentration of the fine particles in the coating solution is small, the thickness of the coating film becomes uniform, it is expected to improve the coverage. The absorbance of the coating solution in the wavelength 660 nm may be 0.

Absorbance values are measured in the following procedure. 3.5 mL coating solution is collected in a quartz cell (10 mm×10 mm×45 mm). The absorbance of the coating solution is measured using an ultraviolet-visible spectrophotometer. For example, an ultraviolet-visible spectrophotometer “UV-1280” manufactured by Shimadzu Corporation is prepared. The temperature of the coating solution during the measurement is 25° C. At this time, the lower limit of the absorbance is 0.000. However, the detection limit of the ultraviolet-visible spectrophotometer used in the absorbance measurement is 0.001. As the zero-point of absorbance, absorbance when ultrapure water having an electric conductivity of 17 MΩ·cm or more and 25° C. is placed in a measuring cell can be used.

### Surface Energy

The surface-energy of the coating solution is less than or equal to 50 mN/m. Here, the surface energy is synonymous with the surface tension. By reducing the value of the surface energy of the coating solution, wettability with the positive electrode active material is improved, and when the coating solution is applied to the surface of the positive electrode active material, the coating solution is uniformly wetted and spread. As a result, the coating film to be formed becomes uniform, and a portion where the thickness of the coating film is insufficient or a portion where the coating is not provided is reduced, and a decrease in the coverage ratio is suppressed.

When the surface-energy of the coating solution is equal to or less than 50 mN/m, it is considered that the thickness of the coating film becomes uniform and an improvement in the coating ratio is expected. The surface-energy of the coating solution may be less than or equal to 45 mN/m and less than or equal to 41 mN/m. The surface-energy of the coating solution is preferably equal to or less than 30 mN/m, and preferably equal to or less than 26 mN/m. The surface-energy of the coating solution is more preferably 20 mN/m or less.

On the other hand, when the surface energy of the coating solution is too small with respect to the surface energy of the positive electrode active material, the coating solution tends to be easily peeled off from the surface of the positive electrode active material. As a result, the coating film formed may become non-uniform, and the coverage may be lowered. For this reason, the surface-energy is preferably 10 mN/m or higher.

The value of the surface energy is measured by the pendant drop method (hanging drop method) using a contact angle meter. For example, a contact angle meter “DMo-502” manufactured by Kyowa Interface Science Co., Ltd. is prepared. Diiodomethane and hexadecane n-are prepared as probing fluids. The coating solution is extruded from the tubule in the probe liquid, and image capture is started after 1000 ms and then the image is captured 300 times at 1000 ms intervals. FAMAS is a multifunctional integrated analysis software. It is used to calculate the surface-energy by reading the captured images and analyzing them based on Young-Laplace method. The temperature of the coating solution during the measurement is 25° C.

### Use

The coating solution of the present disclosure is used to form a coating film on a surface of a positive electrode active material. The positive electrode active material may be composed of one particle or may contain two or more particles. The positive electrode active material may have, for example, a mean particle size (D50) of 1 μm or more and 30 μm or less. “D50” refers to the particle size at which the integration is 50% in the volume-based particle size distribution (integrated distribution). The particle size distribution can be measured by laser diffraction methods.

The positive electrode active material may include any component. The positive electrode active material may include, for example, at least one selected from the group consisting of Li(NiCoMn)O₂, Li(NiCoAl)O₂. For example, “(NiCoMn)” in “Li(NiCoMn)O₂” indicates that the sum of the compositional ratios in parentheses is 1. Li(NiCoMn)O₂ may include, for example, a LiNi_{1/3}Co_{1/3}Mn_{1/3}O₂, LiNi_{0.5}Co_{0.2}Mn_{0.3}O₂. Li(NiCoAl)O₂ may include, for example, a LiNi_{0.8}Co_{0.15}Al_{0.05}O₂.

### Method for Producing Coating Solution

The method for producing the coating solution of the present disclosure is not particularly limited. For example, a coating solution is produced by dissolving a solute in a solvent. When the solute contains both P and B as the M element, the solute may be mixed with the solvent at the same time or may be mixed separately. When a surfactant is added, it may be mixed with the solute at the same time, or may be mixed separately.

### Preparation of Samples

The coating solution and the coated positive electrode active material according to No. 1 12 were produced as follows. Hereinafter, for example, a “coating solution related to No. 1” or the like may be abbreviated as “No. 1”.

### No. 1

6.0 g metaphosphoric acid (manufactured by Fujifilm Wako Pure Chemical Co., Ltd.) was dissolved in 92.14 g ion-exchanged water to produce a coating solution.

As a positive electrode active material, NCM(LiNi_{1/3}Co_{1/3}Mn_{1/3}O₂) was prepared. A slurry (solid concentration: 69% by mass) was prepared by dispersing the powder of the positive electrode active material in the coating solution. The spray dryer “product name: Mini Spray Dryer B-290” available from BUCHI was prepared. The slurry was supplied to a spray dryer to produce a powder of the coated positive electrode active material. The air supply temperature of the spray dryer was 200° C., and the air supply volume was 0.45 m³/min. The coated positive electrode active material was heat treated in air. The heat treatment temperature was 200° C. The heat treatment time was 5 hours.

### No. 2

A coating solution was prepared by dissolving polyethylene glycol monolauryl ether (manufactured by Tokyo Chemical Industry Co., Ltd.) as a polyethylene glycol alkyl ether in a coating solution of No. 1 so that the content thereof was 1.0% by mass. Thereafter, the coated positive electrode active material was produced in the same manner as in No. 1.

### No. 3

A coating solution was prepared by dissolving polyether-modified silicone (KF-945, manufactured by Shin-Etsu Chemical Co., Ltd.) in the coating solution of No. 1 so that the content thereof was 1.0 wt %. Thereafter, the coated positive electrode active material was produced in the same manner as in No. 1.

### No. 4

Phosphate solutions were formed by dissolving 2.15 g metaphosphate (manufactured by Fujifilm Wako Pure Chemical Industries, Ltd.) in 66.05 g ion-exchanged water. Further, boric acid (manufactured by Nacalai Tesque Co., Ltd.) was dissolved in the phosphoric acid solution so that the molar ratio of P and B was 1:1, thereby producing a coating solution. Thereafter, the coated positive electrode active material was produced in the same manner as in No. 1.

### No. 5 to 6

By dissolving the polyethylene glycol alkyl ether in the coating solution of No. 4 so that the concentration thereof is 0.5% by weight, the coating solution of No. 5 dissolves the polyethylene glycol alkyl ether so that the concentration thereof is 1.0% by weight, the coating solution of No. 6 was produced, respectively. Thereafter, the respective coated positive electrode active materials were produced in the same manner as in No. 1.

### No. 7 to 10

By dissolving the polyether-modified silicone in the coating solution of No. 4 so that the concentration thereof becomes 0.01% by mass, the coating solution of No. 7 dissolves the polyether-modified silicone so that the concentration thereof becomes 0.1% by mass, the coating solution of No. 8 dissolves the polyether-modified silicone so that the concentration thereof becomes 0.5% by mass, and the coating solution of No. 9 dissolves the polyether-modified silicone so that the concentration thereof becomes 1.0% by mass, whereby the coating solution of No. 10 was produced. Thereafter, the respective coated positive electrode active materials were produced in the same manner as in No. 1.

### No. 11

Phosphate solutions were formed by dissolving 6.0 g metaphosphate (manufactured by Fujifilm Wako Pure Chemical Industries, Ltd.) in 109.0 g ion-exchanged water. Further, boric acid (manufactured by Nacalai Tesque Co., Ltd.) was dissolved in the phosphoric acid solution so that the molar ratio of P and B was 1:1, thereby producing a coating solution. Thereafter, the coated positive electrode active material was produced in the same manner as in No. 1.

### No. 12

A coating solution was prepared by dissolving polyethylene glycol alkyl ether in a coating solution of No. 11 so as to have a content of 0.5 wt %. Thereafter, the coated positive electrode active material was produced in the same manner as in No. 1.

### Evaluation

Coating solution
Water content

The amount of water contained in the coating solution was measured by a volumetric titration method using a Karl Fischer moisture meter. The results are shown in Tables 1.

### M Element

The concentration (% by mass) of the M element contained in the coating solution was measured by ICP-AES. The results are shown in Tables 1. The concentration of Li contained in the coating solution was measured, but could not be measured because it was not contained or was less than the lower limit of detection.

### Absorbance

### Absorbance

The absorbance of the coating solution was measured by an ultraviolet-visible spectrophotometer. The results are shown in Table 1.

### Surface Energy

The surface energy of the coating solution was measured by the pendant drop method (hanging drop method) using a contact angle meter. The results are shown in Table 1.

### Coated Positive Electrode Active Material

### Coverage Rate

The coverage of the coated positive electrode active material was measured by X-ray Photoelectron Spectroscopy (XPS). As a XPS device, a XPS device “product-name PHIX-tool” manufactured by ULVAC-FI Co., Ltd. was prepared. The sample powder made of the coated positive electrode active material was set in XPS device. Narrow scan analyses were performed with 224 eV pass energies. The measured data were processed by an analysis software “MulTiPak” manufactured by ULVAC FIRE.

Li1s, B1s, P2p, Ni2p3, Co2p3 and Mn2p3 peak areas were measured to determine the ratio of each element (element density). The coverage ratio was determined by the following formula (1).

$$θ = M / ( M + Ni + Co + Mn ) \times 100 \qquad ( 1 )$$

In the above formula (1), θ represents a coverage ratio (%). M, Ni, Co, and Mn represent the ratios of the respective elements. M represents P in the coated positive electrode active materials of No. 1 to 3 and P and B in the coated positive electrode active materials of No. 4 to 12, respectively.

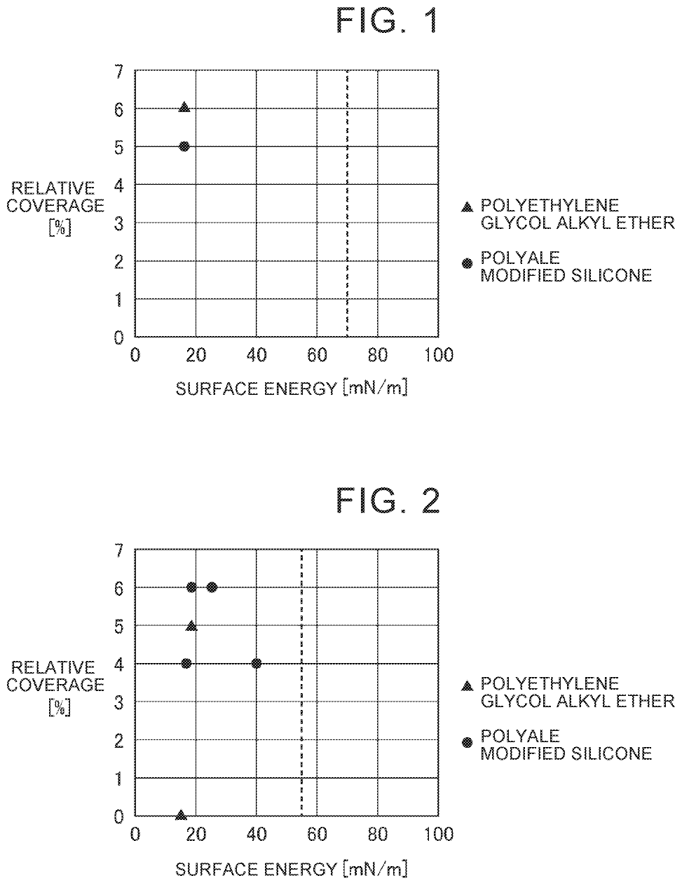

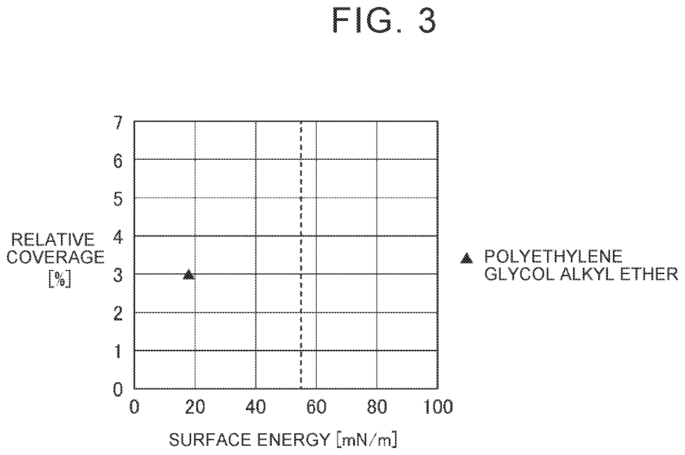

The coverage is shown in Table 1 and FIGS. 1 to 3 as relative values in which the surfactant-free Nos. 1, 4 and 11 are used as reference values. That is, the values of No. 2 and 3 are relative values with No. 1 as a reference value, the values of No. 5 to 10 are relative values with No. 4 as a reference value, and the values of No. 12 are relative values with No. 11 as a reference value.

TABLE 1

| | M element | | Water | Sur- | | | |
|---|---|---|---|---|---|---|---|
| | | Content | content | factant | | Surface- | |
| No. | | (% by | (% by | (% by | Absor- | energy | Coverage |
| 1 | Type | mass) | mass) | weight) | bance | (mN/m) | (%) |
| 1 | P | 2.37 | 93.9 | — | 0.00 | 70.9 | Standard |
| 2 | P | 2.37 | 93.9 | 1.0 | 0.00 | 17.2 | +6*¹ |
| 3 | P | 2.37 | 93.9 | 1.0 | 0.00 | 17.0 | +5*¹ |
| 4 | P, B | 1.54 | 95.0 | — | 0.00 | 56.4 | Standard |
| 5 | P, B | 1.54 | 95.0 | 0.5 | 0.00 | 18.6 | +5*² |
| 6 | P, B | 1.54 | 95.0 | 1.0 | 0.39 | 17.2 | 0*² |
| 7 | P, B | 1.54 | 95.0 | 0.01 | 0.00 | 40.2 | +4*² |
| 8 | P, B | 1.54 | 95.0 | 0.1 | 0.00 | 25.6 | +6*² |
| 9 | P, B | 1.54 | 95.0 | 0.5 | 0.00 | 18.5 | +6*² |
| 10 | P, B | 1.54 | 95.0 | 1.0 | 0.00 | 17.1 | +4*² |
| 11 | P, B | 2.51 | 91.8 | — | 0.00 | 56.6 | Standard |
| 12 | P, B | 2.51 | 91.8 | 0.5 | 0.00 | 18.8 | +3*³ |

*¹Relative to No. 1
*²Relative to No. 4
*³*Relative based on No. 11

### Results

From the results of Table 1 and FIGS. 1 to 3, it is considered that the coating solution according to No. 2, 3, 5, 7 to 10, and 12 can be used to exhibit a satisfactory coating ratio with respect to the positive electrode active material. In addition, it is considered that the inclusion of the surfactant reduces the surface energy, and as a result, the positive electrode active material can exhibit a higher coverage ratio.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A coating solution to be used to form a coating film on a surface of a positive electrode active material, wherein:
the coating solution comprises a solvent and a solute;
the solvent contains water;
the solute contains an M element;
the M element contains at least one kind selected from the group consisting of phosphorus and boron;
a content of the M element in the coating solution is 0.05% by mass or more and 3.0% by mass or less;
a content of lithium in the coating solution is less than 0.1% by mass;
absorbance of the coating solution at a wavelength of 660 nm is 0.1 or less; and
surface energy of the coating solution is 50 mN/m or less.

2. The coating solution according to claim 1, wherein:
the coating solution may further contain a surfactant; and
a content of the surfactant in the coating solution may be 0.01% by mass or more and 1.5% by mass or less.

3. The coating solution according to claim 1, wherein the surface energy of the coating solution may be 15 mN/m or more and 30 mN/m or less.

4. A coating solution to be used to form a coating film on a surface of a positive electrode active material, wherein:
the coating solution comprises a solvent, a solute, and a surfactant;
the solvent contains water;
the solute contains an M element;
the M element contains at least one kind selected from the group consisting of phosphorus and boron;
a content of the M element in the coating solution is 1.5% by mass or more and 2.6% by mass or less;
a content of lithium in the coating solution is less than 0.1% by mass;
absorbance of the coating solution at a wavelength of 660 nm is 0.1 or less;
surface energy of the coating solution is 15 mN/m or more and 30 mN/m or less; and
a content of the surfactant in the coating solution is 0.1% by mass or more and 1.0% by mass or less.
